(19) United States
(12) Patent Application Publication
(10) Pub. No.: US 2017/0269988 A1
(43) Pub. Date: Sep. 21, 2017

(54) DETERMINING PROBLEM SOLUTIONS BASED ON SYSTEM STATE DATA

(71) Applicant: Intel Corporation, Santa Clara, CA (US)

(72) Inventors: Diego A. Alfaro Bergueiro, Belen (CR); Robert L. Vaughn, Portland, OR (US); Gerardo J. Mora Marin, Belen (CR)

(21) Appl. No.: 15/076,051

(22) Filed: Mar. 21, 2016

(51) Int. Cl. G06F 11/07

(52) U.S. Cl. CPC G06F 11/0793; G06F 11/0709; G06F 11/0751; G06F 11/0772; G06F 11/079

(57) ABSTRACT

Apparatuses, methods and storage media associated with a solution provisioning system (“SPS”) are disclosed herein. The SPS may provide solutions for problems experienced by user computing systems (“UCSes”). The SPS may receive system state data (“SSD”) from a system state retriever (“SSR”) of the UCS, such as after an indication from a user that a problem is occurring or after the SSR automatically identifies problems. The SPS may include a solution determiner (“SD”) to determine solutions for problems. The SD may identify common actions which are performed by other users when facing similar problems. Solutions may include predicted solutions, such as when the problem experienced by the UCS is a new problem, and/or confirmed solutions, such as when the problem has been experienced and a solution has been determined before. Other embodiments may be described and/or claimed.

### TECHNICAL FIELD

The present disclosure relates to the field of data processing, in particular, to apparatuses, methods and storage media associated with automated determination and presentation of problem solutions.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

In various scenarios, users of computing devices may experience problems during usage. Some of these problems may be problems such as application failures, freezes, hangs, or unwanted restarts which may severely frustrate continued work or which may even prevent the computing system from operating to some degree. Other problems, however, may be less impactful, such as problems which may annoy or frustrate the user, but which may not prevent continued work. For example, a user may have a non-fatal computer slow-down, or difficulty adding a new printer, or a non-working minor application feature. Oftentimes, users do not consider these problems to be sufficiently “hard” to request help from an IT professional. However, these problems may still provide difficulties for users who are trying to use their systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates example components and information flows used by a user computing system and solution provision system, in accordance with various embodiments.

FIG. 2 illustrates an example process for the user computing system to report problems and present solutions received from the solution provisioning system, in accordance with various embodiments.

FIG. 3 illustrates an example process for the solution provisioning system to provide solutions, in accordance with various embodiments.

FIG. 4 illustrates an example process for the solution provisioning system to determine if a problem is a new problem, in accordance with various embodiments.

FIG. 5 illustrates an example process for the solution provisioning system to predict solutions, in accordance with various embodiments.

FIG. 6 illustrates example paths of stored user actions paths, in accordance with various embodiments.

FIG. 7 illustrates an example predicted solution user action path, in accordance with various embodiments.

FIG. 8 illustrates an example process for the solution provisioning system to determine that a problem has been fixed, in accordance with various embodiments.

FIG. 9 illustrates an example computing environment suitable for practicing various aspects of the present disclosure, in accordance with various embodiments.

FIG. 10 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. As described herein, the term “logic” and “module” may refer to, be part of, or include a System on a Chip, as described below.

In various embodiments, a solution provisioning system (“SPS”) may be configured to provide solutions which may address problems experienced by the users of user computing systems (“UCSes”). In various embodiments the SPS may be configured to receive system state data (“SSD”) from a UCS in order to identify problems and provide solutions to users. In various embodiments, the SSD may include various types of data that may describe one or more states of the computing system, such as, but not limited to: OS data, memory data, processor data, storage data, network data, data regarding open or stored files, user data, etc. In various embodiments, the SSD may be provided by a system state retriever (“SSR”) operating on the UCS. In various embodiments, the SSR may be configured to receive an indication from a user of the UCS that a problem is occurring. In other embodiments, the SSR may be configured to analyze SSD of the UCS to automatically identify problems without requiring explicit indication from a user. In various embodiments, the SSR may obtain SSD from the UCS while a user is allowed to continue work on the UCS and/or attempt to solve the problem themselves.

In various embodiments, the SPS may include a solution determiner (“SD”) to determine solutions for problems experienced at UCSes. In various embodiments, the SD may identify common actions which are performed by users of multiple UCSes when facing the same or similar problems. In various embodiments, the SD may provide solutions to a UCS. The solutions may include predicted solutions, such as when the problem experienced by the UCS is a new problem, and/or confirmed solutions, such as when the problem has been experienced and a solution has been determined before. The SD may be configured to receive indications that a problem has been solved in order to determine actions which lead to solution of the problem. In various embodiments the UCS may include a solution presenter (“SP”) which may be configured to present solutions, in detailed or summarized form to a user. The user may then elect to select a solution, follow the instructions, and indicate if the solution solved the problem.

In various embodiments, the use of the SPS may facilitate more efficient determination of solutions to problems. By allowing users to indicate that a problem is occurring without stopping their work, the SPS may encourage more users to report problems than systems where users are required to speak to a help desk professional and/or to stop work on their computer. Additionally, by utilizing SSD from the UCS, the SPS may be able to provide for retrieval of difficult-to-obtain data to help identify problems. Further, by using SSD obtained from multiple UCSes, the SPS may assist in identifying solutions which have been determined by multiple users of other systems. This may provide for more efficient crowdsourcing of solutions from multiple users without requiring explicit investigation by IT professionals or delay of work by users of UCSes.

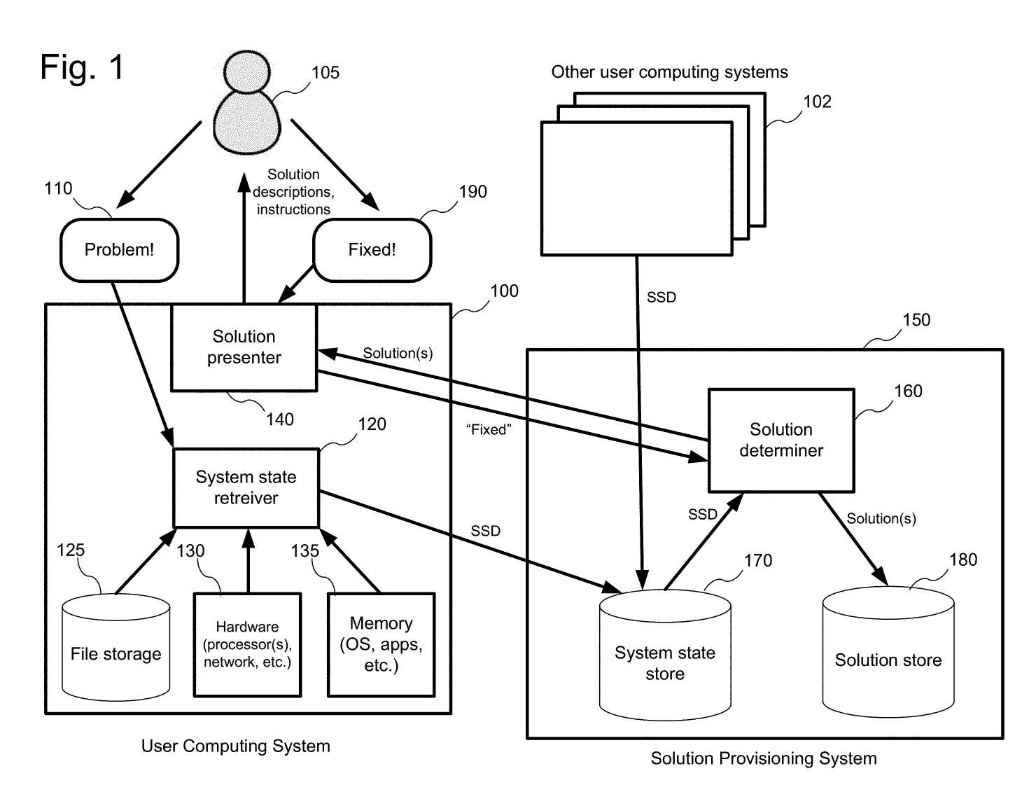

Referring now to FIG. 1, components and information flows used by a UCS 100 and SPS 150 are shown in accordance with various embodiments. It may be noted that, while particular processing, data retrieval, and storage components are illustrated, as well as particular information flows between components, in various embodiments the UCS 100 and/or the SPS 150 may include other components or flows and/or may omit one or more components or flows illustrated in FIG. 1. In various embodiments, the illustrated components may be implemented in hardware and/or software, and may be configured to operate on computing devices of various form factors, such as described below.

In various embodiments, the UCS 100 may include a SSR 120. In various embodiments, the SSR 120 may be configured to obtain SSD relating to one or more states of the UCS 100 and to provide this SSD to the SPS 150. In various embodiments, the SSR 120 may be configured to retrieve file data, such as from a file storage 125. In various embodiments, the file data may include data indicating files which are open on the UCS 100, such as data files that are open at a time that a problem is experienced on the UCS 100. Thus, for example, if the UCS 100 experiences a slowdown when a particular file is open, the SSR 100 may be configured to include an indication of the open file in its SSD, or even all or part of the file itself. In other embodiments, the file data may include data regarding stored files in the file storage 125 or on other local or remote storage (not illustrated). In other embodiments, the SSR 120 may be configured to retrieve stored logs, such as application or operating system logs.

In various embodiments, the SSR 120 may be configured to obtain data from hardware 130 of the UCS 100, such as data describing the operations of one or more processors. For example, if the UCS 100 experiences a slowdown, processor data such as processor load and/or temperature may be included in the SSD. In other embodiments, other hardware-related data may be obtained from the hardware 130, such as, for example, information about network behavior, disk access, power consumption, etc. In other embodiments, the SSR 120 may be configured to obtain SSD from memory 135 of the UCS 100. In various embodiments, the SSD may be configured to obtained data from the memory 135 describing the state of an operating system executing on the processors of the UCS 100. In various embodiments, the SSR 120 may be configured to obtain SSD describing a state of one or more applications executing on processors of the UCS 100. In other embodiments, other data may be obtained from the memory 135.

In various embodiments, the SSR 120 may be configured to obtain user-generated SSD. In various embodiments, the SSR 120 may be configured to obtain one or more actions which are performed by the user 105 on the UCS 100. In various embodiments, actions may include activations of user interface elements, textual input, opening of applications or control panels, selection or opening of files, etc. In various embodiments, these user actions may be obtained through direct measurement of user actions and/or through inference of user actions based on other SSD that is obtained, such as from file storage 125, hardware 130, and/or memory 135. In another example, the SSR 120 may be configured to obtain a user-written description of a problem. In other embodiments, the SSR 120 may be configured to receive indications from the user 105 of windows, web pages, or other interfaces which may be relevant to the problem. In various embodiments, the SSR 120 may be configured to redact sensitive or confidential information from SSD that is obtained from such user-specified interfaces; in some such embodiments, the SSR 120 may be configured to identify sensitive or confidential information based on type or interface field. It may be noted that, while specific examples of SSD which may be obtained by the SSR 120 are described above, in various embodiments the SSD may include other types of embodiments describing states of the UCS 100.

In various embodiments, the SSR 120 may be configured to retrieve SSD in response to an indication received from a user 105 of the UCS 100. In various embodiments, the SSR 120 may provide a problem indication user interface element 110 (“PUT 110”), which is illustrated in the example of FIG. 1 as a button that says “Problem!” In various embodiments, the SSR 120 may be configured to provide the PUT 110 such that it is available during various operations by the user 105 on the UCS 100. In various embodiments, the PUT 110 may thus be provided as part of operation of an operating system of the UCS 100. In various embodiments, the SSR 120 may alternatively be configured to automatically obtain SSD from the UCS 100. In such embodiments, the SSR 120 may continually obtain and store SSD from the UCS 100 during operation of the UCS 100. In various embodiments, the SSR 120 may be configured to include such automatically obtained SSD when receiving an indication from the user 105 that the UCS 100 is experiencing a problem. In some such embodiments, the SSR 120 may be configured to provide a specified amount of automatically obtained SSD. For example, the SSR 120 may be configured, in response to receiving an indication of a problem, to include SSD obtained over the past 10 minutes prior to receipt of the indication. In other embodiments, the SSR 120 may be configured to include a specific size of SSD. In yet other embodiments, the SSR 120 may be configured to determine that a problem is being experienced by the UCS 100, such as by monitoring the UCS 100; in some embodiments, such monitoring may be based on SSD being obtained and stored by the SSR 120.

In various embodiments, the SP 140 may be configured to present one or more solutions to the user 105 for selection and/or performance. In various embodiments, the SP 140 may be configured to receive one or more solutions from the SPS 150 and to present those solutions to the user 105. In various embodiments, the solutions received from the SPS 150 may include various types of information which may be utilized by the user 105 in order to address a problem. A solution may, in various embodiments, include, but is not limited to: instructions to the user 105 to perform one or more actions, images of screens or windows which may be interacted with by the user 105, executable instructions for performance by the UCS 100 to perform a solution to a problem, manuals, frequently asked questions documents, network configuration information, login information, etc. In various embodiments, the SP 140 may be configured to present summaries of one or more solutions and to receive a selection of one or more of the summarized solutions. In various embodiments the SP 140 may be configured to present summaries of predicted solutions, which may be provided from the SPS 150 when the SPS 150 believes that the problem being experienced is new. In various embodiments, the SP 140 may be configured to provide, upon selection of a summary of a solution, a detailed solution related to the selected summary. The SP 140 may also be configured to receive an indication from the user 105 that a problem has been fixed. For example, the SP 140 may provide a solution indication user interface element 190 (“SUI 190”), which is illustrated in the example of FIG. 1 as a button that says “Fixed!” In various embodiments, the SP 140 may be configured to provide the SUI 190 such that it is available after identification of a problem on the UCS 100. In various embodiments, the SUI 190 may be provided as part of operation of an operating system of the UCS 100.

In various embodiments, the SPS 150 may include an SD 160, which may be configured to determine one or more solutions for a problem experienced at the UCS 100. In various embodiments the SD 160 may be configured to obtain SSD from a system state store 170 (“SSS 170”). In various embodiments, the SSS 170 may be configured to receive SSD from the SSR 120. The SSS 170 may, in various embodiments, be configured to receive SSD from multiple UCSes, such as from other UCSes 102. Thus, in various embodiments, the SSS 170 may be configured to store SSD from multiple UCSes. The SD 160 may then be configured to use this aggregated SSD to determine solutions for problems experienced by the UCS 100 and/or by the other UCSes 102. In various embodiments, the SD 160 may be configured to determine solutions based on identification of one or more common actions which are performed in response to similar problems, such actions may be identified from the stored SSD of the SSS 170. In various embodiments, the SD 160 may be configured to store solutions on the solution store 180 (“SS 180”) as well as to provide solutions to the SP 140 for presentation to the user 105. Particular examples of solution determination are described below.

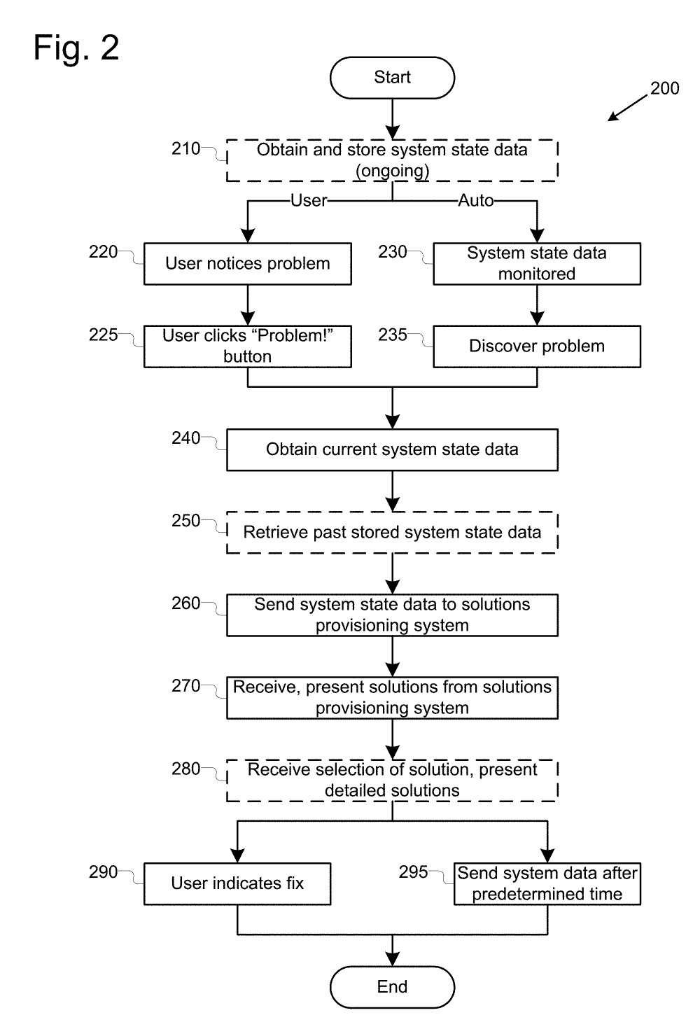

Referring now to FIG. 2, an example process 200 for the UCS 100 to report problems and present solutions received from the SPS 150 is illustrated in accordance with various embodiments. While FIG. 2 illustrates particular operations in a particular order, in various embodiments the operations may be combined, split into parts, and/or omitted. The process may begin at operation 210, where the SRS 120 may begin obtaining and storing SSD for the UCS 100. As discussed above, in various embodiments, the SSD obtained and stored at operation 210 may include user data, user actions, memory data, network state data, processor state data, OS data, etc. Next, the process may operate differently depending on whether the SSR receives an indication from a user 105 of a problem, or whether a problem is detected automatically. Thus, at operation 220, a user 105 may notice a problem with the UCS 100, such as, for example, a slowdown, an error, an incorrectly working feature, etc. If so, then at operation 225, the user 105 may activate the PUI 110 to indicate that the problem is being experienced at the UCS 100. Alternatively, rather than (or in addition to) the user 105 noticing a problem, the SSR 120, at operation 230, may monitor SSD received from the UCS 100 to determine whether any problems are occurring. Then, at operation 235, the SSR 120 may discover a problem with the UCS 100. In various embodiments, at operation 235 the SSR 120 may discover an error has been thrown, such as by an application or OS of the UCS 100. In another embodiment, at operation 235 the SSR 120 may discover that the SSD monitored at operation 230 points to a problem. For example, the UCS 100 may slow down appreciably, experience unusual network traffic, or experience unusual storage accesses. Other techniques for determining that a problem is being experienced may be utilized, as may be understood.

The process may then proceed to operation 240, where the SSR 120 may then obtain current SSD for the UCS 100. As discussed above, in various embodiments, the SSD obtained and stored at operation 240 may include user data, user actions, memory data, network state data, processor state data, OS data, etc. Next, at operation 250, the SSR 120 may optionally retrieve stored SSD, such as SSD that was stored in the process of operation 210. In various embodiments, the SSR 120 may retrieve a limited amount of SSD, such as SSD from a particular amount of time or a particular size of SSD.

The process may then proceed to operation 260, where the SSR 120 may send the SSD to the SPS 150, and more specifically to the SSS 170, so that the SPS 150 may provide solutions to the detected problem. Next at operation 270, the SP 140 of the UCS 100 may receive and present one or more solutions from the SD 160 of the SPS 150. In various embodiments, at operation 270, the SP 140 may receive predicted solutions. For example, the SD 160 may provide predicted solutions to the SP 140 when the SD 160 determines that the problem is a new one. In such cases, the SP 150 may present one or more summaries of the received problems to the user 105 and may invite selection of one of the summarized solutions. In other embodiments, the SD 160 may provide only one solution, such as if the SD 160 determines that the problem of the UCS 100 is not a new problem. In such a case, the SP 140 may present a detailed version of the problem so that the user 105 may perform instructions in the solution. Next, at operation 280, the SP 140 may optionally receive a selection of a summarized solution and may, in response, present a detailed version of the selected solution. In other embodiments, at operation 280 the SP 140 may request additional solution information from the SD 160 or may, alternatively receive the solution prior to presenting summarized solutions.

After presentation of solutions, the SP 140 of the UCS 100 may provide for a determination of whether the problem has been fixed. In one embodiment, at operation 290, the user 105 may indicate that the problem has been fixed, such as by activation of the SUI 190. In an alternative embodiment, at operation 295, the SP 140 may cause the SSR 120 to send SSD to the SD 160 to indicate that the problem has been fixed. In various embodiments, this SSD may be sent after a predetermined time. In various embodiments, this predetermined time may be measured from, for example, the detection of the problem or the provisioning of solutions to the SP 160. After operation 190 or 195, the process may then end.

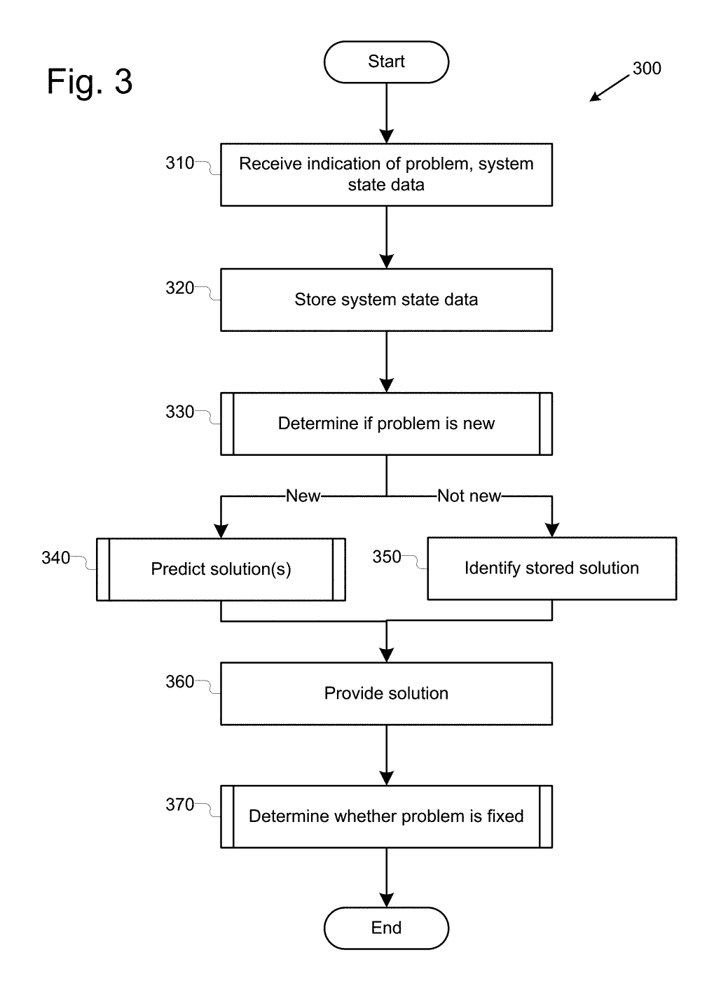

Referring now to FIG. 3, an example process 300 for the SPS 150 to provide solutions is illustrated in accordance with various embodiments. While FIG. 3 illustrates particular operations in a particular order, in various embodiments the operations may be combined, split into parts, and/or omitted. The process may begin at operation 310, where the SPS 150 may receive an indication of a problem experienced at a UCS 100, along with SSD that has been retrieved and sent to the SSS 170 of the SPS 150. As discussed above of, the indication of the problem and the SSD may be initiated by a manual action of the user 105 and/or by automated action of the SSR 120 of the UCS 100. Next, at operation 320, the SSS 170 may store the SSD received from the SSR 120 of the UCS 100.

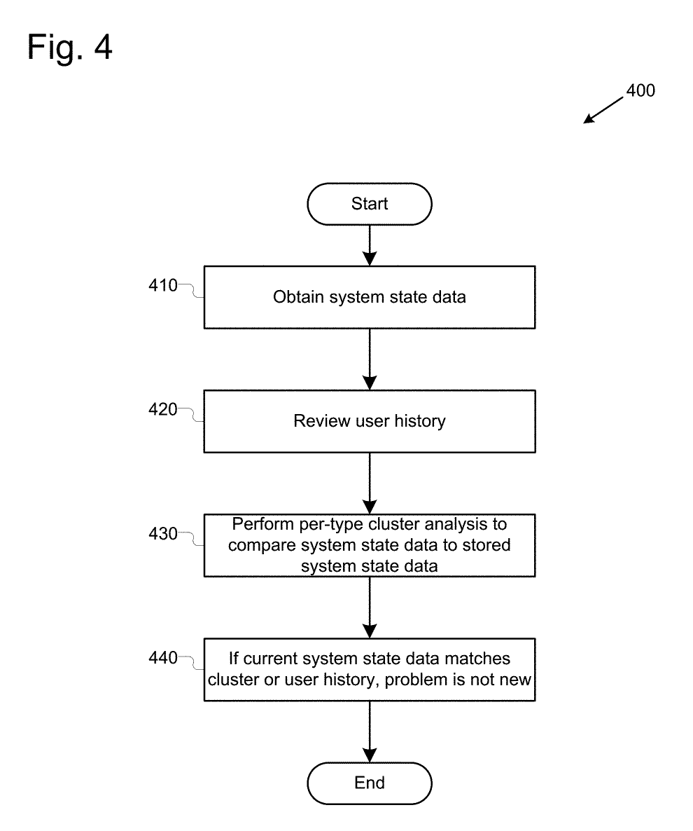

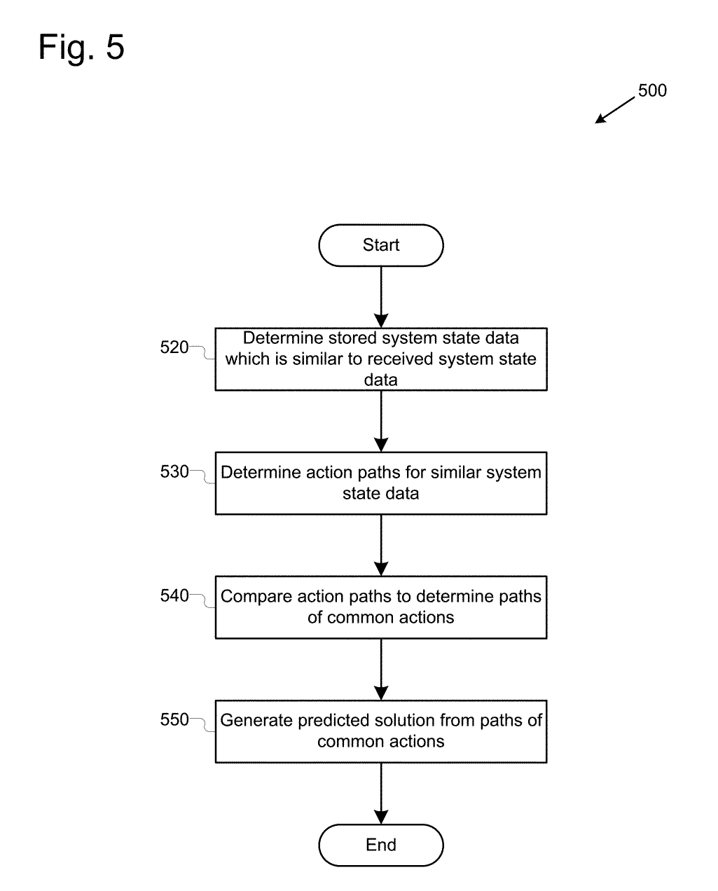

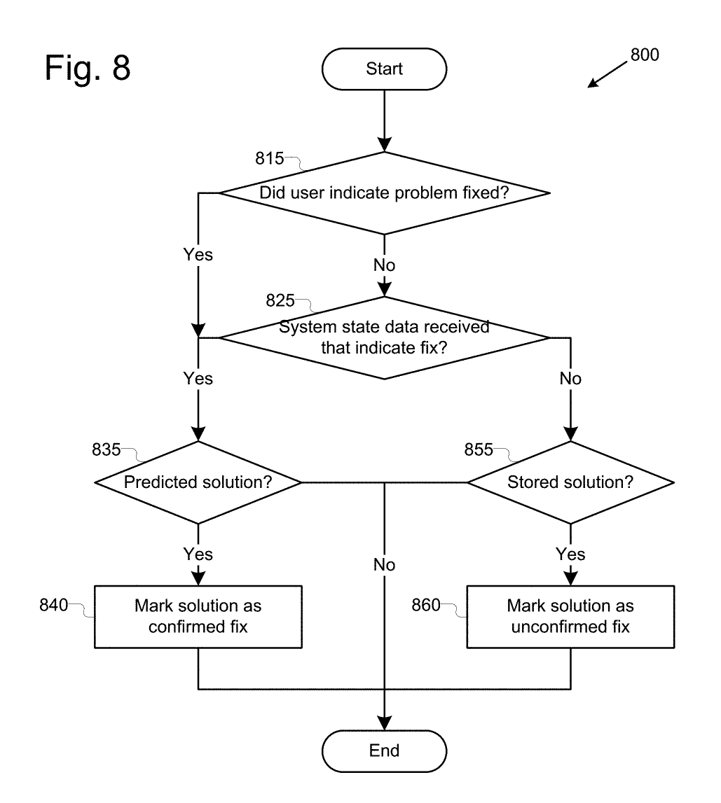

At operation 330, the SD 160 may determine whether problem experienced by the UCS 100 is a new problem. In various embodiments, the SD 160 may determine whether the problem is a new problem in order to determine whether to generate predicted solutions or to utilize a stored confirmed solution, such as might be stored in the SS 180. In various embodiments, operation 330 may be described below with reference to process 400 of FIG. 4. After operation 330, if the problem is determined to be new, then at operation 340, the SD 160 may predict one or more solutions to the problem, such as by finding common actions that have been performed by users of other UCSes 102 when experiencing similar problems. In various embodiments, operation 340 may be described below with reference to process 500 of FIG. 5. However, if, at operation 330, the SD 160 determines that the problem is not new, then at operation 350, the SD 160 may identify a stored solution for the problem, such as from the SS 180. Next at operation 360, the SD 160 may provide the solution to the SP 140. The process may then proceed to operation 370, where the SD 160 may determine whether the problem has been fixed. In various embodiments, operation 370 may be described below with reference to process 800 of FIG. 8. After operation 370, the process may then end.

Referring now to FIG. 4, an example process 400 for the SPS 150 to determine if a problem is a new problem is illustrated in accordance with various embodiments. In various embodiments, process 400 may be performed to implement, in whole or in part, operation 330 of process 300 of FIG. 3. While FIG. 4 illustrates particular operations in a particular order, in various embodiments the operations may be combined, split into parts, and/or omitted. The process may begin at operation 410, where the SD 160 may obtain SSD for the UCS 100 from the SSS 170. Next, at operation 420, the SD 160 may review a history for the user 105 (which may be identified by user data received as part of the SSD) to determine if a similar problem has occurred in the past. Next, at operation 430, the SD 160 may compare the received SSD to other stored SSD. In various embodiments, at operation 430, the SD 160 may perform such comparison using a cluster analysis. For example, the SD 160 may, for each type of system state data, compare the SSD received from the UCS 100 to stored SSD for that type. The SD 160 may then see if the received SSD for that type fits within (or close to) clusters of stored SSD. In other embodiments, the received SSD for that type may be clustered with particular stored SSD because it does not easily cluster with other stored SSD.

Next, at operation 440, the SD 160 may determine whether, based on the review of the user history or the cluster analysis, the problem is a new one or not. In various embodiments, if there is sufficient similarity to the user history or to one or more clusters of SSD, the SD 160 may determine the problem is not new. If, however, there is not much similarity, the SD 160 may determine the problem is new. In either event, the process may then end.

Referring now to FIG. 5, an example process 500 for the SPS 150 to predict solutions is illustrated in accordance with various embodiments. In various embodiments, process 500 may be performed to implement, in whole or in part, operation 340 of process 300 of FIG. 3. While FIG. 5 illustrates particular operations in a particular order, in various embodiments the operations may be combined, split into parts, and/or omitted. The process may begin at operation 510, where the SD 160 may determine stored SSD which is similar to the SSD received from the SSR 120 and which is associated with a solution that has been confirmed to fix a previous problem. Next, at operation 530, the SD 160 may determine one or more paths of user actions associated with from stored SSD that is similar to the SSD received for the current problem. Next, at operation 540, the SD 160 may compare the determined user actions to determine one or more paths of common actions which were performed when similar problems were solved. In various embodiments, the SD 160 may employ a chameleon technique for determining paths of common actions, as may be understood. Then, at operation 550, the SD 160 may generate predicted paths from the determined paths of common actions. The process may then end.

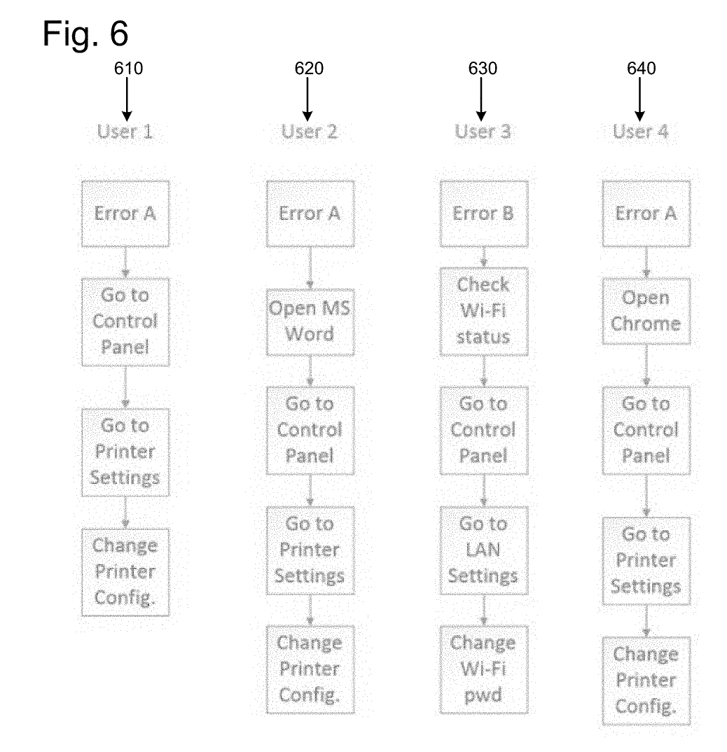

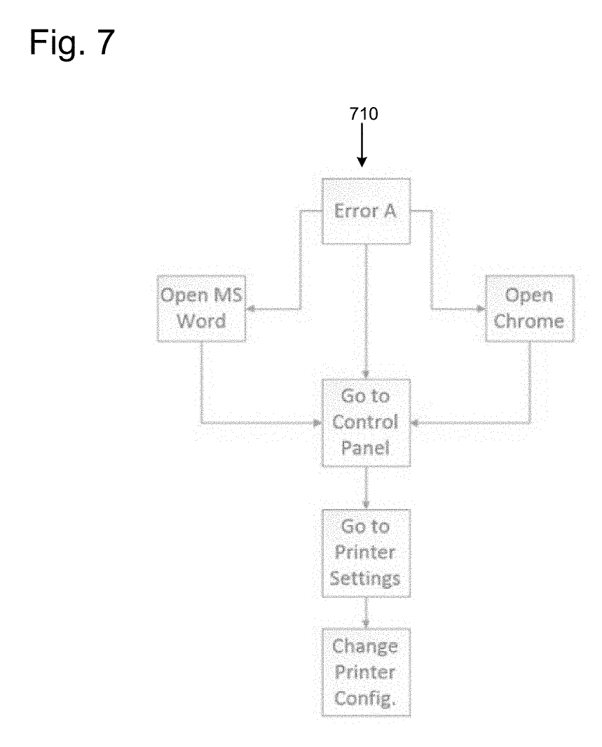

Referring now to FIG. 6, example paths 610, 620, 630, and 640 of stored user actions are illustrated in accordance with various embodiments. In the example of FIG. 6, each of paths 610, 620, and 640 are associated with a correction to printer configuration settings. However, the paths may differ in some ways. For example in paths 620 and 640, while both users 105 reached an action of going to a Control Panel, they opened MS Word or Chrome, respectively, prior to going to a Control Panel, while the user that performed the actions of path 610 did not perform any action prior to going to a Control Panel. However, it can be seen that these paths contain sufficient common actions (e.g., “Go to Control Panel”, “Go to Printer Settings”, “Change Printer Config.”) that they are likely to point to a path of common actions that may be a solution to a common problem. By contrast, path 630 contains only one action in common, and thus does not suggest a solution. Referring now to FIG. 7, an example predicted solution user action path is illustrated in accordance with various embodiments. As can be seen in the example of FIG. 7, the SD 160 may identify the common actions of “Go to Control Panel”, “Go to Printer Settings”, “Change Printer Config.” and may generate a path that includes these common actions. Additionally the generated path may include one or more optional user actions, such as “Open MS Word” or “Open Chrome” which were not common to the various determined paths. In various embodiments, the SD 160 may then provide this path of actions as a solution to the problem (“Error A”) with which it was associated.

FIG. 8 illustrates an example process for the SPS 150 to determine that a problem has been fixed, in accordance with various embodiments. In various embodiments, process 800 may be performed to implement, in whole or in part, operation 370 of process 300 of FIG. 3. While FIG. 8 illustrates particular operations in a particular order, in various embodiments the operations may be combined, split into parts, and/or omitted. The process may begin at operation 810, where the SD 160 may determine whether the user 105 has indicated that the problem is fixed, such as by activating the PUI 110. If not, then at operation 825, the SD 160 may determine whether SSD was received from the SSR 120 that indicates that the problem was fixed. If the determination of either operation 815 or 825 is that the problem was fixed, then at operation 835, the SD 160 may determine whether the solution which was performed by user 105 was a predicted solution. If not, the process may then end. If so, however, then at operation 840, the SD 160 may mark the solution in the SS 180 as a confirmed fix for the problem and then the problem may then end. If, however, no indication was received that the problem was fixed (either at operations 815 or 825), then at operation 855, the SD 160 may determine whether the solution was a stored solution. If the solution is not a stored solution, then process may then end. If the solution was a stored solution, then at operation 860, the SD 160 may mark the solution as unconfirmed as a fix and the process may then end.

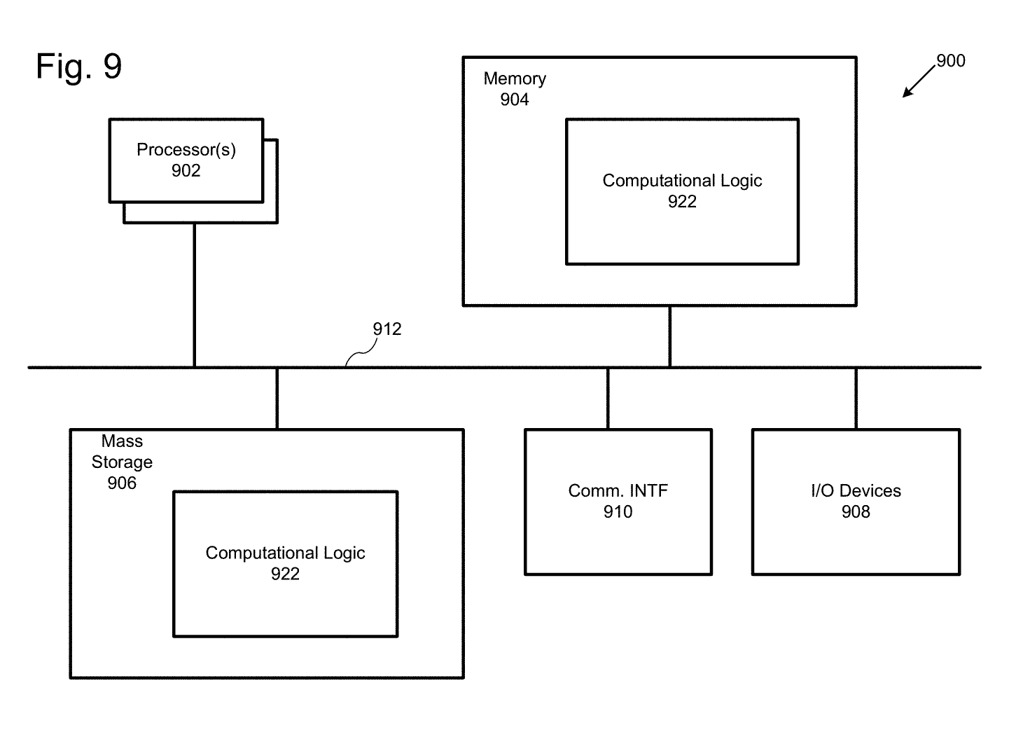

Referring now to FIG. 9, an example computer suitable for practicing various aspects of the present disclosure, including processes of FIGS. 2-8, is illustrated in accordance with various embodiments. As shown, computer 900 may include one or more processors or processor cores 902, and system memory 904. For the purpose of this application, including the claims, the terms “processor” and “processor cores” may be considered synonymous, unless the context clearly requires otherwise. Additionally, computer 900 may include mass storage devices 906 (such as diskette, hard drive, compact disc read only memory (CD-ROM) and so forth), input/output devices 908 (such as display, keyboard, cursor control, remote control, gaming controller, image capture device, and so forth) and communication interfaces 910 (such as network interface cards, modems, infrared receivers, radio transceivers (e.g., Bluetooth, Wi-Fi, Near Field Communications, Radio-frequency identification, and so forth). The elements may be coupled to each other via system bus 912, which may represent one or more buses. In the case of multiple buses, they may be bridged by one or more bus bridges (not shown).

Each of these elements may perform its conventional functions known in the art. In particular, system memory 904 and mass storage devices 906 may be employed to store a working copy and a permanent copy of the programming instructions implementing one or more of the operations associated with the solution determination and presentation techniques described with references to FIGS. 2-8, collectively referred to as computing logic 922. The various elements may be implemented by assembler instructions supported by processor(s) 902 or high-level languages, such as, for example, C, that can be compiled into such instructions. In various embodiments, the system memory 904 or mass storage 906 may include various memory implementations, including integrated flash memory, such as in a System on a Chip, a USB flash drive, SD Card, on SATA SSD, etc.

The permanent copy of the programming instructions may be placed into permanent storage devices 906 in the factory, or in the field, through, for example, a distribution medium (not shown), such as a compact disc (CD), or through communication interface 910 (from a distribution server (not shown)). In embodiments, the programming instructions may be stored in one or more computer readable non-transitory storage media. In other embodiments, the programming instructions may be encoded in transitory storage media, such as signals.

The number, capability and/or capacity of these elements 910-912 may vary. Their constitutions are otherwise known, and accordingly will not be further described.

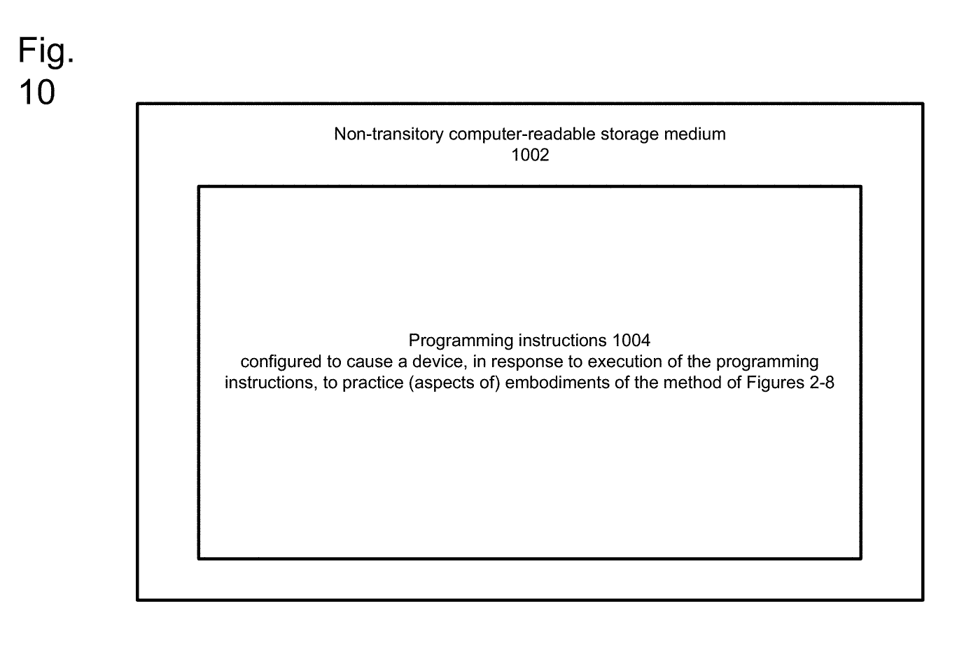

FIG. 10 illustrates an example least one computer-readable storage medium 1002 having instructions configured to practice all or selected ones of the operations associated with the techniques earlier described, in accordance with various embodiments. As illustrated, least one computer-readable storage medium 1002 may include a number of programming instructions 1004. Programming instructions 1004 may be configured to enable a device, e.g., computer 900, in response to execution of the programming instructions, to perform, e.g., various operations of processes of the figures described above, e.g., but not limited to, the various operations performed to perform solution determination and presentation techniques described herein. In alternate embodiments, programming instructions 1004 may be disposed on multiple least one computer-readable storage media 1002 instead.

Referring back to FIG. 9, for one embodiment, at least one of processors 902 may be packaged together with a memory having computational logic 922 configured to practice aspects of processes of FIGS. 2-8. For one embodiment, at least one of processors 902 may be packaged together with a memory having computational logic 922 configured to practice aspects of processes of FIGS. 2-8 to form a System in Package (SiP). For one embodiment, at least one of processors 902 may be integrated on the same die with a memory having computational logic 922 configured to practice aspects of processes of FIGS. 2-8. For one embodiment, at least one of processors 902 may be packaged together with a memory having computational logic 922 configured to practice aspects of processes of FIGS. 2-8 to form a System on Chip (SoC). For at least one embodiment, the SoC may be utilized in, e.g., but not limited to, a computing tablet. (e.g., Wi-Fi, Blue Tooth, Blue Tooth Low Energy, Near Field Communications, Radio-frequency identification (RFID), etc.) and other components as necessary to meet functional and non-functional requirements of the system.

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques. Particular examples of embodiments, described herein include, but are not limited to, the following:

Example 1 may include an apparatus. The apparatus may include one or more computer processors. The apparatus may also include a system state store coupled to the one or more computer processors to receive and store system state data from one or more computing systems, wherein for a first computing system of the one or more computing systems, the system state data may be gathered and provided to the system state store in response to an indication that the first computing system may be experiencing a problem. The apparatus may also include a solution determiner to operate on the one or more computer processors to: receive an indication from a second computing system of the one or more computer systems that the second computing system may be experiencing a problem; receive system state data from the second computing system; determine, using system state data from the system state store, one or more solutions to the problem; and provide one or more instructions to a user of the second computing system to perform a solution of the one or more solutions.

Example 2 may include the apparatus of example 1, wherein the system state store may be to receive and store one or more of: memory state data, user actions, file data, network data, operating system data, and application and system logs, from the one or more computing systems.

Example 3 may include the apparatus of example 1, wherein the system state store may be further to receive and store user information from the one or more computing systems.

Example 4 may include the apparatus of example 1, wherein the solution determiner may be to receive the indication that the second computing system may be experiencing a problem from a user of the second computer system.

Example 5 may include the apparatus of example 1, wherein the indication received by the solution determiner may be an automated indication generated by the second computing system.

Example 6 may include the apparatus of example 1, wherein the system state store may be further to receive and store one or more actions performed by computing systems experiencing problems and the solution determiner may be to determine the one or more solutions to the problem through determination of one or more common actions which have been performed by computing systems experiencing similar problems.

Example 7 may include the apparatus of example 6, wherein determination of one or more common actions may include comparison of paths of actions which have occurred in sequence and formation of groups of actions into one or more paths of common actions.

Example 8 may include the apparatus of any of examples 1-7, wherein the solution determiner may be further to determine whether the problem experienced by the second computing system may be a new problem.

Example 9 may include the apparatus of example 8, wherein the solution determiner may be further to, when the problem experienced by the second computing system may be a new problem, predict one or more potential solutions to the problem.

Example 10 may include the apparatus of any of examples 1-9, wherein the solution determiner may be further to store the one or more determined solutions.

Example 11 may include the apparatus of any of examples 1-10, wherein the solution determiner may be further to receive an indication that a provided solution corrected the problem experienced by the second computing system.

Example 12 may include the apparatus of example 11, wherein the solution determiner may be to receive an indication from a user of the second computing system that a provided solution corrected the problem.

Example 13 may include the apparatus of example 11, wherein the solution determiner may be to automatically determine that a provided solution corrected the problem.

Example 14 may include the apparatus of example 13, wherein the solution determiner may be to automatically determine that a provided solution corrected the problem based at least in part on receipt of system state data from the second computing system.

Example 15 may include an apparatus. The apparatus may include one or more computer processors. The apparatus may also include a system state retriever to operate on the one or more computer processors to: determine that the apparatus may be experiencing a problem; in response to a determination that the apparatus may be experiencing a problem, obtain system state data about the apparatus; and provide the system state data to a computing device for determination of one or more solutions to the problem. The apparatus may also include a solution presenter to operate on the one or more computer processors to receive one or more solutions from the computing device and present the one or more solutions to a user of the apparatus.

Example 16 may include the apparatus of example 15, wherein the system state retriever may be to obtain one or more of: memory state data, user actions, file data, network data, operating system data, and application and system logs of the apparatus.

Example 17 may include the apparatus of example 15, wherein the system state retriever may be further to obtain user information of the apparatus.

Example 18 may include the apparatus of example 15, wherein the system state retriever may be further to obtain user information at least in part in response to an indication from a user that the apparatus may be experiencing a problem.

Example 19 may include the apparatus of example 18, wherein the system state retriever may be further to obtain and store system state data as it may be generated and, to obtain system state data about the apparatus, the system state retriever may obtain stored past system state data in addition to current system state data.

Example 20 may include the apparatus of example 19, wherein the system state retriever may be to obtain stored past system state data which has been obtained during a predetermined period prior to the determination that the apparatus may be experiencing a problem.

Example 21 may include the apparatus of any of examples 15-20, wherein the system state retriever may be to determine that the apparatus may be experiencing a problem through receipt of an indication from a user of the apparatus that the apparatus may be experiencing a problem.

Example 22 may include the apparatus of any of examples 15-21, wherein the solution presenter may be to present actions to be taken by a user of the apparatus.

Example 23 may include the apparatus of any of examples 15-22, wherein the solution presenter may be to: receive one or more predicted solutions; present summaries of the one or more predicted solutions to the user of the second computing system; receive a selection of a summarized solution; and present a detailed solution based on the selected summarized solution.

Example 24 may include a method. The method may include storing, by a computing device, system state data received from one or more computing systems, wherein for a first computing system of the one or more computing systems, the system state data may be gathered and provided to the computing device in response to an indication that the first computing system may be experiencing a problem. The method may also include receiving, by the computing device, an indication from a second computing system of the one or more computer systems that the second computing system may be experiencing a problem. The method may also include receiving, by the computing device, system state data from the second computing system. The method may also include determining, by the computing device, using stored system state data, one or more solutions to the problem. The method may also include providing, by the computing device, one or more instructions to a user of the second computing system to perform a solution of the one or more solutions.

Example 25 may include the method of example 24, wherein storing system state data may include storing one or more of: memory state data, user actions, file data, network data, operating system data, and application and system logs, from the one or more computing systems.

Example 26 may include the method of example 24, wherein storing system state data may include storing user information from the one or more computing systems.

Example 27 may include the method of example 24, wherein receiving an indication may include receiving an indication from a user of the second computer system.

Example 28 may include the method of example 24, wherein receiving an indication may include receiving an automated indication generated by the second computing system.

Example 29 may include the method of example 24, wherein storing system state data may include storing one or more actions performed by computing systems experiencing problems and determining one or more solutions may include determining one or more common actions which have been performed by computing systems experiencing similar problems.

Example 30 may include the method of example 29, wherein determining one or more common actions may include comparing paths of actions which have occurred in sequence and forming groups of actions into one or more paths of common actions.

Example 31 may include the method of any of examples 24-30, and may further include determining, by the computing device, whether the problem experienced by the second computing system may be a new problem.

Example 32 may include the method of example 31, and may further include, when the problem experienced by the second computing system may be a new problem, predicting, by the computing device, one or more potential solutions to the problem.

Example 33 may include the method of any of examples 24-32, and may further include storing, by the computing device, the one or more determined solutions.

Example 34 may include the method of any of examples 24-33, and may further include receiving an indication that a provided solution corrected the problem experienced by the second computing system.

Example 35 may include the method of example 34, wherein receiving an indication that a provided solution corrected the problem may include receiving an indication from a user of the second computing system that a provided solution corrected the problem.

Example 36 may include the method of example 34, and may further include automatically determining, by the computing device, that a provided solution corrected the problem.

Example 37 may include the method of example 36, wherein automatically determining that a provided solution corrected the problem may include determining based at least in part on receipt of system state data from the second computing system.

Example 38 may include one or more computer-readable media containing instructions written thereon that, in response to execution by a computing device, cause the computing device to store system state data received from one or more computing systems, wherein for a first computing system of the one or more computing systems, the system state data may be gathered and provided to the computing device in response to an indication that the first computing system may be experiencing a problem. The instructions may also cause the computing device to receive an indication from a second computing system of the one or more computer systems that the second computing system may be experiencing a problem; receive system state data from the second computing system; determine, using stored system state data, one or more solutions to the problem; and provide one or more instructions to a user of the second computing system to perform a solution of the one or more solutions.

Example 39 may include the computer-readable media of example 38, wherein store system state data may include store one or more of: memory state data, user actions, file data, network data, operating system data, and application and system logs, from the one or more computing systems.

Example 40 may include the computer-readable media of example 38, wherein store system state data may include store user information from the one or more computing systems.

Example 41 may include the computer-readable media of example 38, wherein receive an indication may include receive an indication from a user of the second computer system.

Example 42 may include the computer-readable media of example 38, wherein receive an indication may include receive an automated indication generated by the second computing system.

Example 43 may include the computer-readable media of example 38, wherein store system state data may include store one or more actions performed by computing systems experiencing problems and determine one or more solutions may include determine one or more common actions which have been performed by computing systems experiencing similar problems.

Example 44 may include the computer-readable media of example 43, wherein determine one or more common actions may include compare paths of actions which have occurred in sequence and form groups of actions into one or more paths of common actions.

Example 45 may include the computer-readable media of any of examples 38-44, wherein the instructions may be further to cause the computing device to determine whether the problem experienced by the second computing system may be a new problem.

Example 46 may include the computer-readable media of example 45, wherein the instructions may be further to cause the computing device to, when the problem experienced by the second computing system may be a new problem, predict one or more potential solutions to the problem.

Example 47 may include the computer-readable media of any of examples 38-46, wherein the instructions may be further to cause the computing device to store the one or more determined solutions.

Example 48 may include the computer-readable media of any of examples 38-47, wherein the instructions may be further to cause the computing device to receive an indication that a provided solution corrected the problem experienced by the second computing system.

Example 49 may include the computer-readable media of example 48, wherein receive an indication that a provided solution corrected the problem may include receive an indication from a user of the second computing system that a provided solution corrected the problem.

Example 50 may include the computer-readable media of example 48, wherein the instructions may be further to cause the computing device to automatically determine that a provided solution corrected the problem.

Example 51 may include the computer-readable media of example 50, wherein automatically determine that a provided solution corrected the problem may include determine based at least in part on receipt of system state data from the second computing system.

Example 52 may include an apparatus. The apparatus may include means for storing system state data received from one or more computing systems, wherein for a first computing system of the one or more computing systems, the system state data may be gathered and provided to the apparatus in response to an indication that the first computing system may be experiencing a problem. The apparatus may also include: means for receiving an indication from a second computing system of the one or more computer systems that the second computing system may be experiencing a problem; means for receiving system state data from the second computing system; means for determining, using stored system state data, one or more solutions to the problem; and means for providing, one or more instructions to a user of the second computing system to perform a solution of the one or more solutions.

Example 53 may include the apparatus of example 52, wherein means for storing system state data may include means for storing one or more of: memory state data, user actions, file data, network data, operating system data, and application and system logs, from the one or more computing systems.

Example 54 may include the apparatus of example 52, wherein means for storing system state data may include means for storing user information from the one or more computing systems.

Example 55 may include the apparatus of example 52, wherein means for receiving an indication may include means for receiving an indication from a user of the second computer system.

Example 56 may include the apparatus of example 52, wherein means for receiving an indication may include means for receiving an automated indication generated by the second computing system.

Example 57 may include the apparatus of example 52, wherein means for storing system state data may include means for storing one or more actions performed by computing systems experiencing problems and means for determining one or more solutions may include means for determining one or more common actions which have been performed by computing systems experiencing similar problems.

Example 58 may include the apparatus of example 57, wherein means for determining one or more common actions may include means for comparing paths of actions which have occurred in sequence and means for forming groups of actions into one or more paths of common actions.

Example 59 may include the apparatus of any of examples 52-58, and may further include means for determining whether the problem experienced by the second computing system may be a new problem.

Example 60 may include the apparatus of example 59, and may further include means for, when the problem experienced by the second computing system may be a new problem, predicting one or more potential solutions to the problem.

Example 61 may include the apparatus of any of examples 52-60, and may further include means for storing the one or more determined solutions.

Example 62 may include the apparatus of any of examples 52-61, and may further include means for receiving an indication that a provided solution corrected the problem experienced by the second computing system.

Example 63 may include the apparatus of example 62, wherein means for receiving an indication that a provided solution corrected the problem may include means for receiving an indication from a user of the second computing system that a provided solution corrected the problem.

Example 64 may include the apparatus of example 62, and may further include means for automatically determining that a provided solution corrected the problem.

Example 65 may include the apparatus of example 64, wherein means for automatically determining that a provided solution corrected the problem may include means for determining based at least in part on receipt of system state data from the second computing system.

Example 66 may include a method. The method may include: determining, by a computing system, that the computing system may be experiencing a problem; in response to a determination that the computing system may be experiencing a problem, obtaining, by the computing system, system state data about the computing system; providing, by the computing system, the system state data to a computing device for determination of one or more solutions to the problem; receiving, by the computing system, one or more solutions from the computing device; and presenting, by the computing system, the one or more solutions to a user of the computing system.

Example 67 may include the method of example 66, wherein obtaining system state data may include obtaining one or more of: memory state data, user actions, file data, network data, operating system data, and application and system logs of the computing system.

Example 68 may include the method of example 66, wherein obtaining system state data may include obtaining user information of the computing system.

Example 69 may include the method of example 66, wherein obtaining user information may include obtaining user information at least in part in response to an indication from a user that the computing system may be experiencing a problem.

Example 70 may include the method of example 69, wherein the method further may include obtaining and storing system state data as it may be generated by the computing system and obtaining system state data about the computing system may include obtaining stored past system state data in addition to current system state data.

Example 71 may include the method of example 70, wherein obtaining stored past system state data may include obtaining stored past system state data which has been obtained during a predetermined period prior to the determination that the computing system may be experiencing a problem.

Example 72 may include the method of any of examples 66-71, wherein determining that the computing system may be experiencing a problem may include receiving an indication from a user of the computing system that the computing system may be experiencing a problem.

Example 73 may include the method of any of examples 66-72, wherein presenting the one or more solutions may include presenting actions to be taken by a user of the computing system.

Example 74 may include the method of any of examples 66-73, wherein presenting the one or more solutions may include: receiving one or more predicted solutions; presenting summaries of the one or more predicted solutions to the user of the second computing system; receiving a selection of a summarized solution; and presenting a detailed solution based on the selected summarized solution.

Example 75 may include one or more computer-readable media containing instructions written thereon that, in response to execution by a computing system, cause the computing system to: determine that the computing system may be experiencing a problem; in response to a determination that the computing system may be experiencing a problem, obtain system state data about the computing system; provide the system state data to a computing device for determination of one or more solutions to the problem; receive one or more solutions from the computing device; and present the one or more solutions to a user of the computing system.

Example 76 may include the computer-readable media of example 75, wherein obtain system state data may include obtain one or more of: memory state data, user actions, file data, network data, operating system data, and application and system logs of the computing system.

Example 77 may include the computer-readable media of example 75, wherein obtain system state data may include obtain user information of the computing system.

Example 78 may include the computer-readable media of example 75, wherein obtain user information may include obtain user information at least in part in response to an indication from a user that the computing system may be experiencing a problem.

Example 79 may include the computer-readable media of example 78, wherein the instructions may be further to cause the computing system to obtain and store system state data as it may be generated by the computing system and obtain system state data about the computing system may include obtain stored past system state data in addition to current system state data.

Example 80 may include the computer-readable media of example 79, wherein obtain stored past system state data may include obtain stored past system state data which has been obtained during a predetermined period prior to the determination that the computing system may be experiencing a problem.

Example 81 may include the computer-readable media of any of examples 75-80, wherein determine that the computing system may be experiencing a problem may include receive an indication from a user of the computing system that the computing system may be experiencing a problem.

Example 82 may include the computer-readable media of any of examples 75-81, wherein present the one or more solutions may include present actions to be taken by a user of the computing system.

Example 83 may include the computer-readable media of any of examples 75-82, wherein present the one or more solutions may include: receive one or more predicted solutions; present summaries of the one or more predicted solutions to the user of the second computing system; receive a selection of a summarized solution; and present a detailed solution based on the selected summarized solution.

Example 84 may include an apparatus. The apparatus may include: means for determining that the apparatus may be experiencing a problem; means for, in response to a determination that the apparatus may be experiencing a problem, obtaining system state data about the apparatus; means for providing the system state data to a computing device for determination of one or more solutions to the problem; means for receiving one or more solutions from the computing device; and means for presenting the one or more solutions to a user of the apparatus.

Example 85 may include the apparatus of example 84, wherein means for obtaining system state data may include means for obtaining one or more of: memory state data, user actions, file data, network data, operating system data, and application and system logs of the apparatus.

Example 86 may include the apparatus of example 84, wherein means for obtaining system state data may include means for obtaining user information of the apparatus.

Example 87 may include the apparatus of example 84, wherein means for obtaining user information may include means for obtaining user information at least in part in response to an indication from a user that the apparatus may be experiencing a problem.

Example 88 may include the apparatus of example 87, wherein the apparatus further may include means for obtaining and storing system state data as it may be generated by the apparatus and means for obtaining system state data about the apparatus may include means for obtaining stored past system state data in addition to current system state data.

Example 89 may include the apparatus of example 88, wherein means for obtaining stored past system state data may include means for obtaining stored past system state data which has been obtained during a predetermined period prior to the determination that the apparatus may be experiencing a problem.

Example 90 may include the apparatus of any of examples 84-89, wherein means for determining that the apparatus may be experiencing a problem may include means for receiving an indication from a user of the apparatus that the apparatus may be experiencing a problem.

Example 91 may include the apparatus of any of examples 84-90, wherein means for presenting the one or more solutions may include means for presenting actions to be taken by a user of the apparatus.

Example 92 may include the apparatus of any of examples 84-91, wherein means for presenting the one or more solutions may include: means for receiving one or more predicted solutions; means for presenting summaries of the one or more predicted solutions to the user of the second apparatus; means for receiving a selection of a summarized solution; and means for presenting a detailed solution based on the selected summarized solution.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus, comprising:
one or more computer processors;
a system state store coupled to the one or more computer processors to receive and store system state data from one or more computing systems, wherein for a first computing system of the one or more computing systems, the system state data is gathered and provided to the system state store in response to an indication that the first computing system is experiencing a problem; and
a solution determiner to operate on the one or more computer processors to:
receive an indication from a second computing system of the one or more computer systems that the second computing system is experiencing a problem;
receive system state data from the second computing system;
determine, using system state data from the system state store, one or more solutions to the problem; and
provide one or more instructions to a user of the second computing system to perform a solution of the one or more solutions.

2. The apparatus of claim 1, wherein the system state store is to receive and store one or more of: memory state data, user actions, file data, network data, operating system data, application and system logs, and user information, from the one or more computing systems.

3. The apparatus of claim 1, wherein the solution determiner is to receive the indication that the second computing system is experiencing a problem from a user of the second computer system.

4. The apparatus of claim 1, wherein the indication received by the solution determiner is an automated indication generated by the second computing system.

5. The apparatus of claim 1, wherein:
the system state store is further to receive and store one or more actions performed by computing systems experiencing problems; and
the solution determiner is to determine the one or more solutions to the problem through determination of one or more common actions which have been performed by computing systems experiencing similar problems.

6. The apparatus of claim 5, wherein determination of one or more common actions comprises:
comparison of paths of actions which have occurred in sequence; and
formation of groups of actions into one or more paths of common actions.

7. The apparatus of claim 1, wherein the solution determiner is further to determine whether the problem experienced by the second computing system is a new problem.

8. The apparatus of claim 7, wherein the solution determiner is further to, when the problem experienced by the second computing system is a new problem, predict one or more potential solutions to the problem.

9. The apparatus of claim 1, wherein the solution determiner is further to store the one or more determined solutions.

10. The apparatus of claim 1, wherein the solution determiner is further to receive an indication that a provided solution corrected the problem experienced by the second computing system.

11. The apparatus of claim 10, wherein the solution determiner is to receive an indication from a user of the second computing system that a provided solution corrected the problem.

12. The apparatus of claim 10, wherein the solution determiner is to automatically determine that a provided solution corrected the problem.

13. The apparatus of claim 12, wherein the solution determiner is to automatically determine that a provided solution corrected the problem based at least in part on receipt of system state data from the second computing system.

14. An apparatus, comprising:
one or more computer processors;
a system state retriever to operate on the one or more computer processors to:
determine that the apparatus is experiencing a problem;
in response to a determination that the apparatus is experiencing a problem, obtain system state data about the apparatus; and
provide the system state data to a computing device for determination of one or more solutions to the problem; and
a solution presenter to operate on the one or more computer processors to:
receive one or more solutions from the computing device; and
present the one or more solutions to a user of the apparatus.

15. The apparatus of claim 14, wherein the system state retriever is to obtain one or more of: memory state data, user actions, file data, network data, operating system data, application and system logs, and user information of the apparatus.

16. The apparatus of claim 14, wherein the system state retriever is further to obtain user information at least in part in response to an indication from a user that the apparatus is experiencing a problem.

17. The apparatus of claim 16, wherein:
the system state retriever is further to obtain and store system state data as it is generated; and
to obtain system state data about the apparatus, the system state retriever obtains stored past system state data in addition to current system state data.

18. The apparatus of claim 17, wherein the system state retriever is to obtain stored past system state data which has been obtained during a predetermined period prior to the determination that the apparatus is experiencing a problem.

19. The apparatus of claim 14, wherein the system state retriever is to determine that the apparatus is experiencing a problem through receipt of an indication from a user of the apparatus that the apparatus is experiencing a problem.

20. The apparatus of claim 14, wherein the solution presenter is to present actions to be taken by a user of the apparatus.

21. The apparatus of claim 14, wherein the solution presenter is to:
receive one or more predicted solutions;
present summaries of the one or more predicted solutions to the user of the second computing system;
receive a selection of a summarized solution; and
present a detailed solution based on the selected summarized solution.

22. A method, comprising:
storing, by a computing device, system state data received from one or more computing systems, wherein for a first computing system of the one or more computing systems, the system state data is gathered and provided to the computing device in response to an indication that the first computing system is experiencing a problem;
receiving, by the computing device, an indication from a second computing system of the one or more computer systems that the second computing system is experiencing a problem;
receiving, by the computing device, system state data from the second computing system;
determining, by the computing device, using stored system state data, one or more solutions to the problem; and
providing, by the computing device, one or more instructions to a user of the second computing system to perform a solution of the one or more solutions.

23. The method of claim 22, wherein:
storing system state data comprises storing one or more actions performed by computing systems experiencing problems; and
determining one or more solutions comprises determining one or more common actions which have been performed by computing systems experiencing similar problems.

24. One or more computer-readable media containing instructions written thereon that, in response to execution by a computing device, cause the computing device to:
store system state data received from one or more computing systems, wherein for a first computing system of the one or more computing systems, the system state data is gathered and provided to the computing device in response to an indication that the first computing system is experiencing a problem;
receive an indication from a second computing system of the one or more computer systems that the second computing system is experiencing a problem;
receive system state data from the second computing system;
determine, using stored system state data, one or more solutions to the problem; and
provide one or more instructions to a user of the second computing system to perform a solution of the one or more solutions.

25. The computer-readable media of claim 24, wherein:
store system state data comprises store one or more actions performed by computing systems experiencing problems; and
determine one or more solutions comprises determine one or more common actions which have been performed by computing systems experiencing similar problems.
